(19) United States
(12) Patent Application Publication
(10) Pub. No.: US 2020/0083501 A1
(43) Pub. Date: Mar. 12, 2020

(54) PLUG CONNECTOR HAVING A LOW PROFILE AND RESILIENT FLANGE

(71) Applicant: Apple Inc., Cupertino, CA (US)

(72) Inventors: Hani Esmaeili, Santa Clara, CA (US); Eric S. Jol, San Jose, CA (US); Sean T. McIntosh, Cupertino, CA (US)

(21) Appl. No.: 16/126,830

(22) Filed: Sep. 10, 2018

(51) Int. Cl. H01M 2/10; G06F 1/16

(52) U.S. Cl. CPC H01M 2/1066; H01M 2/1094; H01M 2220/30; G06F 1/1635; G06F 1/1632

(57) ABSTRACT

A low profile plug connector assembly is adapted for use in an accessory for an electronic device and includes a plug connector coupled to a thin and resilient flange. The flange is formed to match a curvature of a portion of the accessory and provides a resilient yet flexible structure for the plug connector that allows the plug connector to move during mating and demating. The low profile structure consumes minimal space and enables the accessory to have an aesthetically appealing appearance.

### FIELD

The described embodiments relate generally to connector assemblies that have resilient and low-profile structural features so they can fit within the constrained dimensions of electronic devices. More particularly, the present embodiments relate to a plug connector that is attached to a resilient and flexible flange that is formed to match a curvature of an electronic assembly. The flange holds the connector in place while providing a flexible yet resilient structure that allows the connector to flex during mating and demating events. The low profile geometry of the flange enables the electronic device in which it is mounted to have reduced size and improved aesthetics.

### BACKGROUND

The present invention generally relates to electrical connectors and in particular to connector assemblies that can be incorporated into electronic devices and/or accessories.

A wide variety of electronic devices are available for consumers today. Many of these devices have connectors that facilitate communication with and/or charging of a corresponding device. Typically these connectors are part of a male plug connector and female receptacle connector system in which the plug connector can be inserted into and mated with the receptacle connector so that digital and analog signals can be transferred between the contacts in each connector. Often the female connector in the connector system is included in a host electronic device such as a portable media player, a smart phone, a tablet computer, a laptop computer, a desktop computer or the like. The plug connector in the connector system is often included in an accessory device such as a smart battery case, charging cable, a docking station, an audio sound system or the like. As the form factor for electronic devices and the associated accessories continues to be reduced, new connectors and assemblies that support the connectors are needed that consume less space and improve the reliability, aesthetics and/or usability of the devices for the consumer.

### SUMMARY

Embodiments of the invention pertain to connector assemblies that have resilient low profile structures that are adapted to be integrated within an electronic device. In some embodiments the connectors can be dual orientation (also referred to as “reversible”) connectors. In various embodiments a plug connector is bonded to a resilient yet flexible flange that is formed to match a curvature of the electronic device so the connector can be integrated into the electronic device in an aesthetically pleasing way.

In some embodiments a connector assembly for an electronic device comprises a connector including a plurality of contacts positioned to make electrical contact with a corresponding connector. A flange is attached to the connector wherein the flange includes a curved portion that extends below the connector and a flat portion coupled to the curved portion and spaced apart from the connector. In various embodiments the flat portion extends in a parallel relationship with a tab of the connector.

In some embodiments the connector tab includes an opening formed at a major surface and the plurality of electrical contacts are positioned within the opening. In various embodiments the plug connector comprises a conductive frame that generally defines a shape of the connector tab. In some embodiments the connector is axisymmetric and can be mated with the mating connector in a first orientation and in a second orientation and wherein the second orientation is rotated 180 degrees about an axis of symmetry with respect to the first orientation.

In some embodiments the connector and the flange form a substantially “U” shaped structure. In various embodiments the flange is attached to the connector at a pair of transverse extensions that protrude from the connector. In some embodiments the flange is attached to the connector with one or more welds. In some embodiments a flexible electrical circuit extends out of the base and is formed along the curved portion of the flange.

In some embodiments an accessory for an electronic device comprises a housing including a bottom wall extending between first, second, third and fourth sidewalls to define a cavity that is sized and shaped to receive the electronic device. A plug connector is positioned within the cavity at an internal surface of the first sidewall and is configured to be inserted into a corresponding receptacle connector of the electronic device when the electronic device is received within the cavity. A flange is coupled to the connector and to the housing, the flange having a curved portion that substantially matches a curvature of the first sidewall and a straight portion that extends substantially parallel to the plug connector.

In some embodiments the flange is attached to the connector at a pair of transverse extensions that protrude from the connector. In various embodiments the flange is attached to the connector with one or more welds. In some embodiments the accessory further comprises an accessory receptacle connector disposed within the housing and having a receiving opening positioned at an outside surface of the housing. A first plane is aligned with a length and a width of the plug connector and a second plane is aligned with a length and a width of the accessory receptacle connector. A third plane is perpendicular to the first and the second planes and is substantially aligned with a base of the plug connector and the receiving opening of the accessory receptacle connector.

In some embodiments the first plane and the second plane are separated by a distance that is less than a depth of the cavity. In various embodiments a thickness of the connector tab is at least three times a thickness of the flange. In some embodiments the flange is formed from a flexible metal sheet. In various embodiments a flexible electrical circuit extends out of the base and is formed along the curved portion of the flange. In some embodiments the plug connector includes a conductive frame that generally defines a shape of the connector tab and includes openings on both first and second major surfaces. In some embodiments electronic contacts are disposed in the openings on both the first and second major surfaces and the electronic contacts are surrounded by an encapsulant. In some embodiments the flange enables the plug connector to be deflected during insertion and removal of the electronic device from the cavity.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is simplified perspective view of an accessory in the process of receiving an electronic device, according to an embodiment of the invention;

FIG. 2 is a simplified perspective view of the connector assembly shown in FIG. 1;

FIG. 3 illustrates a simplified partial cross-sectional view of the accessory shown in FIG. 1;

FIG. 4 illustrates a simplified exploded view of the plug connector and flexible electrical circuit that are used in the accessory shown in FIGS. 1-3;

FIG. 5 illustrates a simplified exploded view of the plug connector assembly shown in FIGS. 1-4;

FIG. 6 illustrates a simplified cross-sectional view of the accessory shown in FIGS. 1 and 3;

FIG. 7 illustrates a simplified cross-sectional view of an accessory having a flexible housing with a detent position, according to an embodiment of the invention; and

FIGS. 8 and 9 illustrate simplified cross-sectional views of an accessory having a retractable plug connector, according to an embodiment of the invention.

### DETAILED DESCRIPTION

Some embodiments of the disclosure relate to connector assemblies for electronic devices. In some instances, embodiments of the disclosure are particularly well suited for accessories that can be used with portable electronic media devices because of their potentially small form factor.

For example, in some embodiments an accessory for an electronic device includes a cavity sized to receive the electronic device. A mating plug connector is attached to an inside surface of a sidewall of the accessory and is positioned within the cavity to mate with a corresponding receptacle connector of the electronic device when the electronic device is received within the cavity. The plug connector is attached to a low-profile and resilient flange that is curved to substantially match a curvature of a sidewall of the accessory. The flange provides the connector with enough resiliency to allow the plug connector to deflect slightly during insertion and removal of electronic device, while also enabling the connector assembly to fit into a relatively thin sidewall of the accessory so the accessory can have an aesthetically appealing appearance.

In order to better appreciate the features and aspects of connector assemblies having low-profile and resilient flanges according to the present disclosure, further context for the disclosure is provided in the following section by discussing one particular implementation of an electronic accessory according to embodiments of the present disclosure. These embodiments are for example only and other embodiments can be employed in other electronic accessories and devices such as, but not limited to docking stations, computers, watches, media players and other devices.

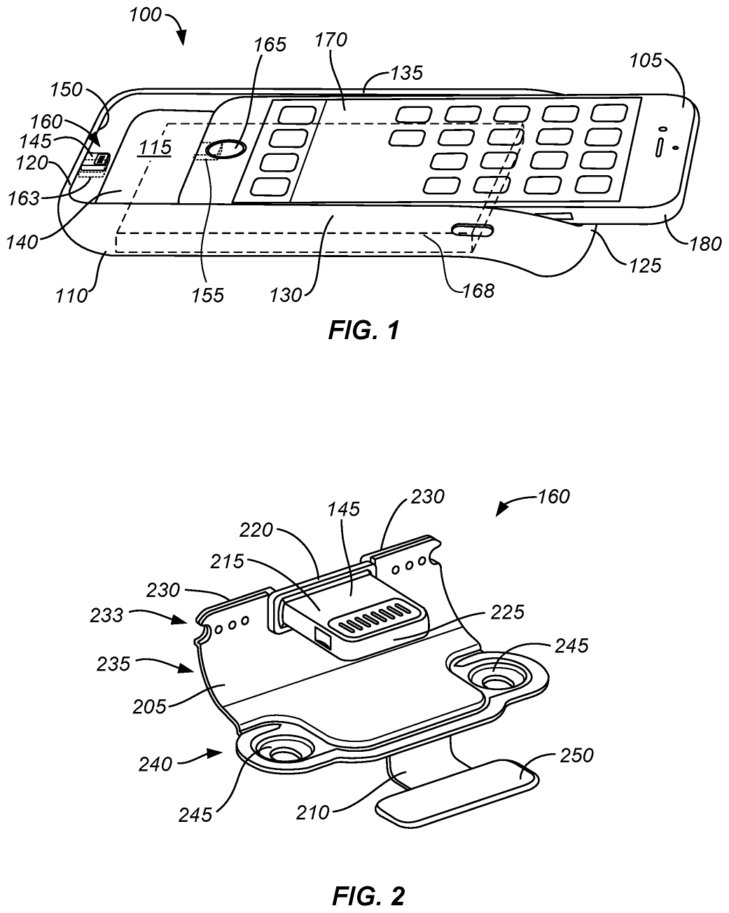

FIG. 1 illustrates a simplified perspective view of an accessory 100 in the process of receiving an electronic device 105. As shown in FIG. 1, accessory 100 is a smart battery case that includes a housing 110 having a cavity 115 sized and shaped to receive electronic device 105. Cavity 115 is defined by a first sidewall 120 opposite a second sidewall 125, with third and fourth sidewalls 130, 135, respectively, extending therebetween. A bottom wall 140 extends between first, second, third and fourth sidewalls 120, 125, 130, 135, respectively. A plug connector 145 is positioned at an internal surface 150 of first sidewall 120 of housing 110 and is arranged to be inserted into a corresponding receptacle connector 155 of electronic device 105. Plug connector 145 can be part of a connector assembly 160 that provides a resilient low-profile structure that attaches the plug connector to accessory 100, as described in more detail below. Accessory further comprises an accessory receptacle connector 163 that is positioned at an exterior surface of accessory 100. A rechargeable battery 168 is disposed within accessory 100 and is positioned adjacent bottom wall 140.

In the embodiment illustrated in FIG. 1, the use of a resilient low-profile connector assembly 160 can enable accessory 100 to have relatively thin and uniform sidewalls, 120, 125, 130, 135 formed around electronic device 105. That is, as compared to traditional connector assemblies that have thicker profiles, first sidewall 120 of accessory 100 would traditionally need to be made larger (e.g., wider or thicker) than left, right and top sidewalls 125, 130, 135, respectively, to accommodate a larger traditional connector assembly structure. By using a resilient low-profile connector assembly 160, embodiments of the invention enable accessory 100 to have substantially uniform and relatively thin sidewalls resulting in a more aesthetically pleasing appearance.

In this particular embodiment, electronic device 105 includes a multipurpose button 165 as an input component, a touch screen display 170 as both an input and output component, and a speaker 175 as an output component, all of which are housed within a device housing 180. For simplicity, various internal components, such as the control circuitry, graphics circuitry, bus, memory, storage device and other components are not shown in FIG. 1. Although electronic device 105 is described as one particular electronic device, embodiments of the invention are suitable for use with a multiplicity of electronic devices that interface with an accessory through a mating connector.

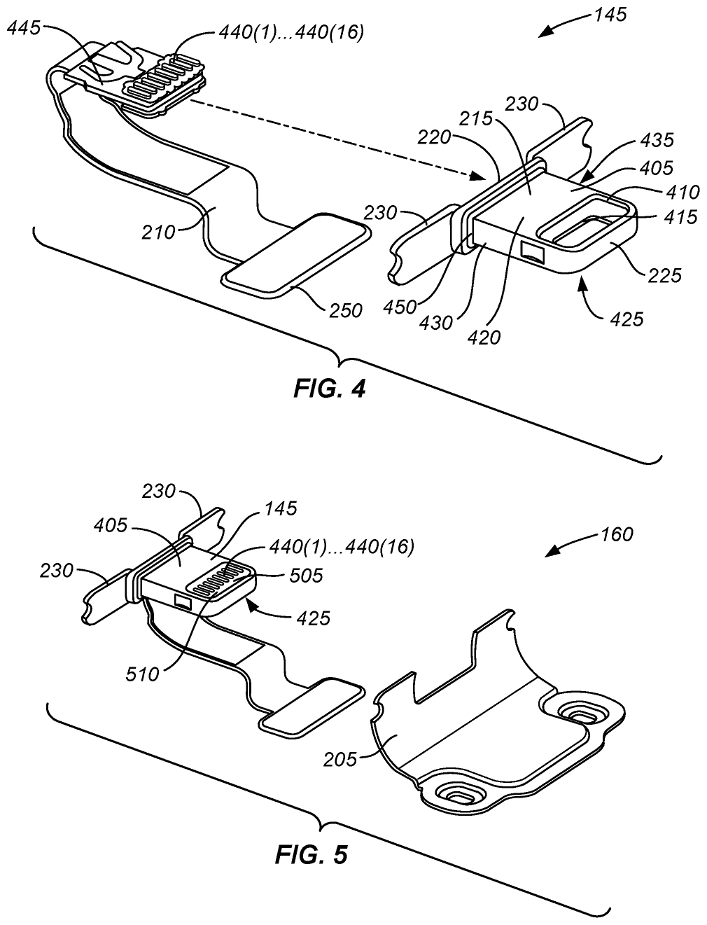

FIG. 2 illustrates a simplified perspective view of connector assembly 160 shown in FIG. 1, with the connector assembly removed from accessory 100 (see FIG. 1). As shown in FIG. 2, connector assembly 160 includes plug connector 145 coupled to a flange 205, and a flexible circuit 210 that is electrically coupled to the plug connector (shown in more detail in FIGS. 4 and 5). Plug connector 145 includes a connector tab 215 extending from a base 220 to a distal end 225. Plug connector 145 has transverse extensions 230 disposed at base 220. Flange 205 is bonded to transverse extensions 230 with one or more welds, a braze joint, an adhesive joint or other method. In some embodiments a breaking strength of the bond can be designed to be less than a breaking strength of receptacle connector 155 (see FIG. 1) and/or connector tab 215. This can enable the bond to function as a safety feature so if a force is applied to connector assembly 160 through electronic device 105 (see FIG. 1) the bond breaks before the electronic device.

In some embodiments, flange 205 has a first flat portion 233 that is attached to connector base 220. First flat portion 233 can be attached to curved portion 235 that is curved and substantially matches a curvature of first sidewall 120 (see FIG. 1) of accessory housing 110 and enables the flange to wrap around (or be spaced apart from) a portion of connector tab 215. Flange 205 has a second flat portion 240 that is straight and extends substantially parallel to connector tab 215 so that the plug connector 145 and the flange form a substantially “U” shaped structure. In some embodiments flange 205 is formed from a flexible metal sheet that holds connector tab 215 in place during mating and demating of electronic device 105 while simultaneously providing a low-profile structure that secures and positions connector tab 215 at an appropriate position within accessory 100 with a minimal size.

Flange 205 can be formed using stamping, molding or any other suitable process. In some embodiments flange 205 can be formed from a stainless steel sheet that is between 0.1 millimeters and 0.5 millimeters thick to provide a balance of strength, support, and enough resiliency to allow connector tab 215 to deflect during insertion and removal of electronic device 105. In one embodiment flange 205 is formed from a sheet that is between 0.2 millimeters and 0.4 millimeters thick. In further embodiments, flange 205 can be attached to accessory 100 with one or more fasteners (not shown in FIG. 2) that can be secured to mounting bosses 245. In other embodiments flange 205 can be secured to accessory 100 (see FIG. 1) using adhesive, welding or another bonding process. Flexible electrical circuit 210 extends out of base 220, is formed along flange 205 and includes a termination plate 250 that is coupled to circuitry within the accessory, as described in more detail below. In some embodiments a ratio of a thickness of connector tab 215 to flange 205 is greater than 3, and in various embodiments is between 4 to 6 and in one embodiment is 5.

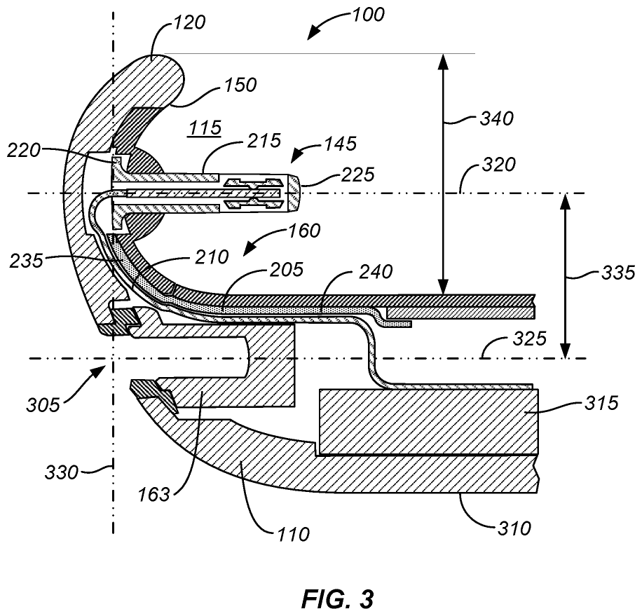

FIG. 3 illustrates a simplified partial cross-sectional view of accessory 100 in the region of plug connector 145. As shown in FIG. 3, accessory 100 includes plug connector 145 positioned at internal surface 150 of first sidewall 120 of housing 110. Connector tab 215 extends from base 220 to a distal end 225 and extends in a direction towards second sidewall 125 (see FIG. 1). Connector tab 215 is positioned to be inserted into corresponding receptacle connector 155 (see FIG. 1) of electronic device 105. Accessory 100 further includes receptacle connector 163 positioned within housing 110 and having a receiving opening 305 positioned at outside surface 310 of accessory 100. In some embodiments receptacle connector 163 can be coupled to plug connector 145 with electrical circuitry 315 and can be used to communicate bidirectional data and power between electronic device 105 (see FIG. 1), battery 168 (see FIG. 1) and an external device coupled to receptacle connector 163.

As discussed above, the resilient low-profile structure of connector assembly 160 can enable first sidewall 120 of housing 110 to have a relatively thin profile that is substantially similar to a profile of second, third and fourth sidewalls 125, 130, 135, respectively, resulting in an aesthetically appealing appearance of accessory 100. As further shown in FIG. 3, first portion 235 of flange 205 follows a curvature of first sidewall 120 of housing 110 and flexible electronic circuit 210 extends out of base 220 and is formed along first portion 235 and second portion 240 of flange 205. Flexible electronic circuit 210 is electrically coupled to circuitry 315 within accessory 100 and can be used to couple power and/or data to electronic device 105 (see FIG. 1) including coupling stored power from battery 168 to the electronic device.

The resilient low-profile structure of connector assembly 160 can also enable plug connector 145 and accessory receptacle connector 163 to be mounted in substantially the same vertical plane (e.g., be stacked) as shown in FIG. 3. More specifically, in some embodiments plug connector 145 is positioned in a first plane 320 that is aligned with a length and a width of the connector tab 215 (e.g., plane 320 extends perpendicular “out of the paper” to the image in FIG. 3) and is centered within the plug connector, and accessory receptacle connector 163 is positioned in a second plane 325 aligned with a length and a width of the receptacle connector 163 (e.g., plane 325 extends perpendicular “out of the paper” to the image in FIG. 3) and is centered on the receptacle connector.

First plane 320 is substantially parallel to second plane 325. A third plane 330 is perpendicular to first plane 320 and second plane 325 and is substantially aligned with base 220 of plug connector 145 and receiving opening 305 of accessory receptacle connector 163 such that plug connector 145 is “stacked” on top of receptacle connector 163 with a gap therebetween. This configuration enables plug connector 145 and receptacle connector 163 to be positioned within a relatively compact region of accessory 100 enabling an aesthetically appealing appearance of the accessory. In some embodiments first plane 320 and second plane 325 are separated by a distance 335 that is less than a depth 340 of cavity 115.

FIG. 4 illustrates a simplified exploded view of one embodiment of plug connector 145 and flexible electrical circuit 210. As shown in FIG. 4, plug connector can include a conductive frame 405 that generally defines a shape of the plug connector and includes openings 410, 415 formed through both first and second opposing major surfaces 420, 425, respectively. Transverse flanges 230 can be formed as a portion of conductive frame 405 and extend out of and away from third 430 and fourth 435 opposing side surfaces of plug connector 145. A plurality of electrical contacts 440(1) . . . 440(16) (eight on each major surface 420, 425) can be coupled to both top and bottom surfaces of a circuit board 445 and are positioned in openings 410, 415 on both the first and second major surfaces 420, 425, respectively. Flexible electrical circuit 210 is attached to circuit board 445 and extends to termination plate 250.

In some embodiments plug connector 145 is axisymmetric and has first plurality of contacts 440(1) . . . 440(8) on first major surface 420 opposite a second plurality of contacts 440(9) . . . 440(16) on second major surface 425 such that the plug connector can be inserted into a receptacle connector in a first orientation and also in a second orientation where the first orientation is rotated 180 degrees about a center axis of the connector plug. In some embodiments the center axis of the connector plug can be an axis of symmetry that extends along a length of the connector plug.

In some embodiments, connector tab 215 is between 5-10 millimeters wide, between 1-3 millimeters thick and has an insertion depth (the distance from distal end 225 of connector tab to boss 450) of between 5-15 mm. Also in some embodiments, connector tab 215 has a length that is greater than its width which is greater than its thickness. In other embodiments, the length and width of connector tab 215 are within 1.0 and 0.2 millimeters of each other. In one particular embodiment, connector tab 215 is 6.7 millimeters wide, 1.5 millimeters thick and has an insertion depth (the distance from distal end 225 of connector tab 215 to flange boss 450) of 6.6 millimeters. In other embodiments, connector tab 215 has the same 6.7 millimeter width and 1.5 millimeter height but a longer length.

In some embodiments conductive frame 405 can have a cavity extending from base 220 to pair of openings 410, 415. Conductive frame 405 can be fabricated using a variety of techniques such as, for example, a metal injection molding process (MIM), a cold heading process or a billet machining process. A MIM process may provide a great deal of flexibility in achieving a desired geometry and can result in a part that is close to the final desired shape with minimal post machining operations. In some embodiments, alternative processes such as plastic injection molding and plating can be used to form conductive frame 405.

FIG. 5 illustrates a simplified exploded view of plug connector assembly 160. As shown in FIG. 5, plug connector 145 is fully assembled and is prepared to be bonded to flange 205. Plug connector 145 includes a first mating surface 505 formed on first major surface 405. In some embodiments a second mating surface (not shown) is formed on second major surface 425. A plurality of electrical contacts 440(1) . . . 440(16) are disposed at the first and second mating surfaces and each contact is surrounded by an encapsulant 510.

In some embodiments, electrical contacts 440(1) . . . 440(16) can be disposed on only one mating surface, particularly in embodiments employed in docking stations as the electronic device is always mated in the same orientation. When connector tab 215 is inserted into a corresponding receptacle connector, first and second major surfaces 420, 425 fit within a housing of the receptacle connector or host device into which the receptacle connector is incorporated.

Although the embodiments discussed herein use an example axisymmetric plug connector, connector assembly 160 can be used with any type of plug or receptacle connector. For example, in other embodiments connector assembly 160 can include a Universal Serial Bus (USB) connector that can be a Type A, B, C, mini, micro or other type of USB connector. In further embodiments connector assembly 160 can include an RJ-45, HDMI, or other type of connector. One of skill in the art will appreciate that connector assembly 160 can be used with a myriad of connectors (based on an industry standard or proprietary) and the embodiments described herein are not limited to any particular type or configuration of connector.

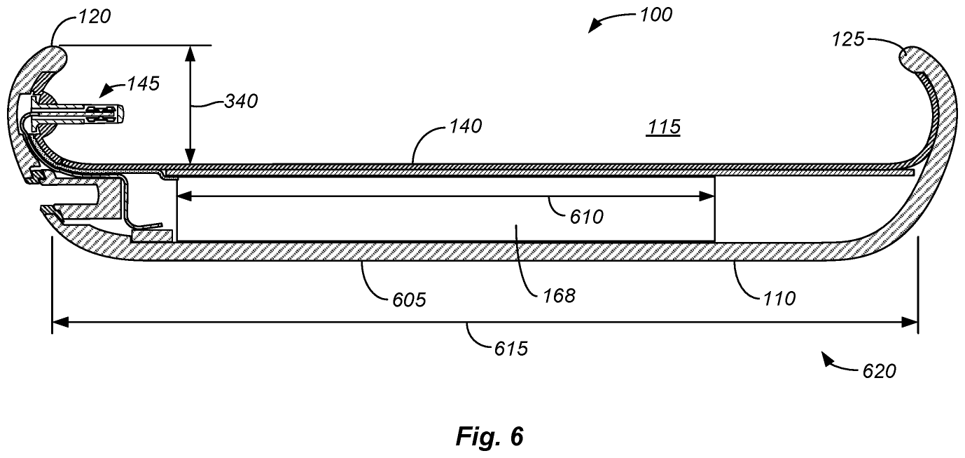

FIG. 6 illustrates a simplified cross-sectional view of accessory 100 illustrated in FIG. 1. As shown in FIG. 6, accessory 100 includes housing 110 having cavity 115 sized and shaped to receive electronic device 100 (see FIG. 1). Cavity 115 is defined by first sidewall 120 positioned opposite second sidewall 125, with third and fourth sidewalls (not shown in FIG. 6) extending therebetween. Bottom wall 140 extends between first, second, third and fourth sidewalls 120, 125, 130, 135, respectively. Cavity 115 has a depth 340 measured from cavity 115 opening to bottom wall 140. Because of the resilient low-profile structure of connector assembly 160, a cross-sectional profile (e.g., thickness) of first sidewall 120 is substantially similar to a cross-sectional profile (e.g., thickness) of second sidewall 125, providing an aesthetically appealing appearance for accessory 100.

Rechargeable battery 168 is positioned between bottom wall 140 and a back wall 605 of accessory 100. In some embodiments accessory housing 110 can be at least partially made from a flexible material such that second sidewall 125 and a portion of back wall 605 can be deflected in a clockwise direction with respect to FIG. 6 (as shown in FIG. 1) so that electronic device 105 can be inserted within cavity 115 and engaged with plug connector 145. In some embodiments a battery length 610, may be less than a back wall length 615, providing a flexible region 620 for accessory to bend, as described above an as illustrated in FIG. 1.

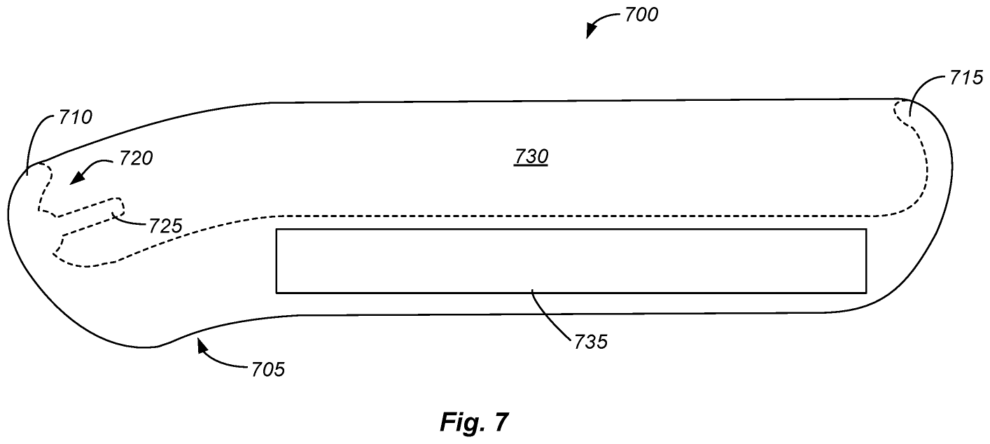

FIG. 7 illustrates a simplified cross-sectional view of an accessory 700 that is similar to accessory 100 (shown in FIGS. 1, 3 and 6) however accessory 700 has a flexible region 705 disposed adjacent first sidewall 710 instead of adjacent second sidewall 715. Further, accessory 700 can be equipped with a first and a second detent position to facilitate insertion and removal of an electronic device. More specifically in some embodiments accessory 700 can employ a connector assembly 720 that is similar to connector assembly 160, however connector assembly 720 can be equipped with a flange that is formed in such a way that when flexible region 705 of accessory 700 is deflected in a counter-clockwise direction (with respect to the image shown in FIG. 7) the flange is put into a second stable position and physically holds first sidewall 710 of accessory as shown in FIG. 7. In this position accessory 700 is held in the bent position shown in FIG. 7 by forces imparted by the flange only and not by any external forces. In this position, an electronic device can be easily mated to connector 725 and then the user can apply force to accessory 700 to move it back to a second stable position where accessory is once again in a flat state and the electronic device is fully seated within cavity 730. In some embodiments a length of batter 735 can be longer than previous embodiments because flexible region 705 is disposed adjacent the circuitry instead of adjacent an opposite end of the accessory. In further embodiments battery 735 can be made to be at least partially flexible and can be flexed when flexible region 705 is flexed to insert or remove the electronic device.

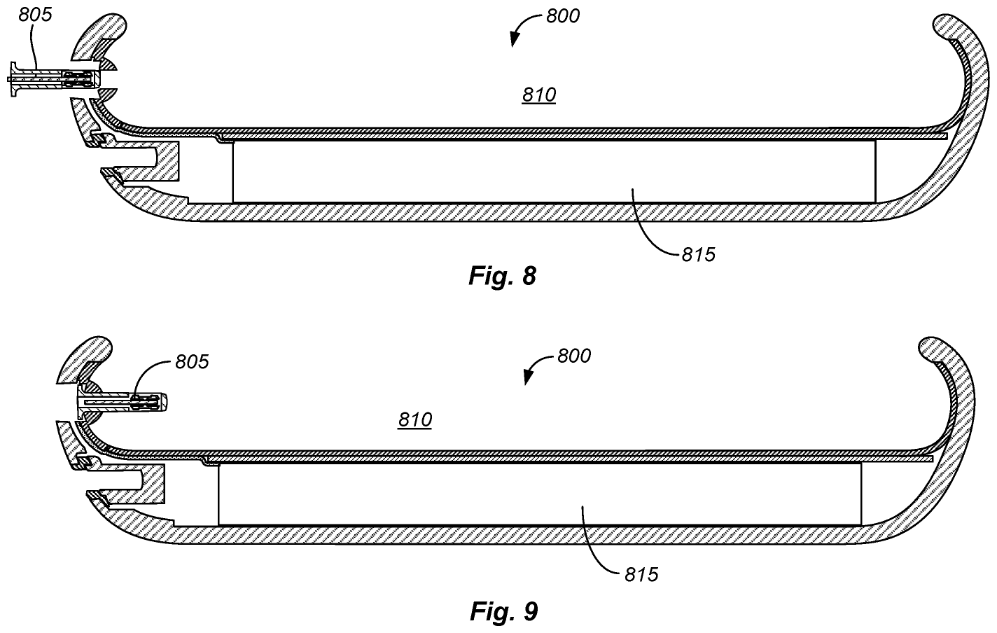

FIGS. 8 and 9 illustrate an embodiment of an accessory 800 with a retractable plug connector 805. As shown in FIG. 8, accessory 800 is similar to accessory 100 illustrated in FIGS. 1, 3 and 6, however accessory 100 has a plug connector 805 that can be retracted out of cavity 810 and deployed within the cavity. More specifically, plug connector 805 can have both a retracted position, as shown in FIG. 8, and a deployed position as shown in FIG. 9. In some embodiments this feature enables plug connector 805 to be retracted (see FIG. 8) so an electronic device can be easily inserted or removed from cavity 810 without any required flexure of accessory. Once an electronic device is inserted within cavity 810, plug connector 805 can be deployed and engaged with a corresponding receptacle connector in an electronic device (see FIG. 9). Because retractable plug connector 805 can remove the need to bend a portion of accessory 800 to insert the electronic device, battery 815 can be elongated as compared to previously discussed embodiments. This can enable a higher capacity battery than used in the embodiments discussed above.

Although accessories 100, 700 and 800 are described as one particular type of electronic accessory, embodiments of the invention are suitable for use with a multiplicity of electronic accessories and devices that include a plug connector that has resilient and low-profile flange. For example, any device or accessory that has a connector can be used with the invention. In some instances, embodiments of the invention are particularly well suited for use with accessories and/or electronic media devices because of their potentially small form factor. As used herein, an electronic media device includes any device with at least one electronic component that may be used to present human-perceivable media. Such devices may include, for example, portable music players (e.g., MP3 devices and Apple's iPod devices), portable video players (e.g., portable DVD players), cellular telephones (e.g., smart telephones such as Apple's iPhone devices), video cameras, digital still cameras, projection systems (e.g., holographic projection systems), gaming systems, PDAs, desktop computers, as well as tablet (e.g., Apple's iPad devices), laptop or other mobile computers. Some of these devices may be configured to provide audio, video or other data or sensory output.

For simplicity, various internal components, such as the control circuitry, graphics circuitry, bus, memory, storage device and other components of the electronic device and accessory are not shown in the figures.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

What is claimed is:

1. A connector assembly for an electronic device comprising:
a connector including a plurality of contacts positioned to make electrical contact with a corresponding connector; and
a flange attached to the connector, the flange including a curved portion that extends below the connector and a flat portion coupled to the curved portion and spaced apart from the connector.

2. The connector assembly of claim 1 wherein the flat portion extends in a parallel relationship with a tab of the connector.

3. The connector assembly of claim 2 wherein the connector tab includes an opening formed at a major surface and the plurality of electrical contacts are positioned within the opening.

4. The connector assembly of claim 3 wherein the plug connector comprises a conductive frame that generally defines a shape of the connector tab.

5. The connector assembly of claim 1 wherein the connector is axisymmetric and can be mated with the mating connector in a first orientation and in a second orientation and wherein the second orientation is rotated 180 degrees about an axis of symmetry with respect to the first orientation.

6. The connector assembly of claim 1 wherein the connector and the flange form a substantially “U” shaped structure.

7. The connector assembly of claim 1 wherein the flange is attached to the connector at a pair of transverse extensions that protrude from the connector.

8. The connector assembly of claim 7 wherein the flange is attached to the connector with one or more welds.

9. The connector assembly of claim 1 wherein a flexible electrical circuit extends out of the base and is formed along the curved portion of the flange.

10. An accessory for an electronic device comprising:
a housing including a bottom wall extending between first, second, third and fourth sidewalls to define a cavity that is sized and shaped to receive the electronic device;
a plug connector positioned within the cavity at an internal surface of the first sidewall and configured to be inserted into a corresponding receptacle connector of the electronic device when the electronic device is received within the cavity; and
a flange coupled to the connector and to the housing, the flange having a curved portion that substantially matches a curvature of the first sidewall and a straight portion that extends substantially parallel to the plug connector.

11. The accessory of claim 10 wherein the wherein the flange is attached to the connector at a pair of transverse extensions that protrude from the connector.

12. The accessory of claim 11 wherein the flange is attached to the connector with one or more welds.

13. The accessory of claim 10 further comprising an accessory receptacle connector disposed within the housing and having a receiving opening positioned at an outside surface of the housing;
wherein a first plane is aligned with a length and a width of the plug connector;
a second plane is aligned with a length and a width of the accessory receptacle connector;
a third plane is perpendicular to the first and the second planes and is substantially aligned with a base of the plug connector and the receiving opening of the accessory receptacle connector.

14. The accessory of claim 13 wherein the first plane and the second plane are separated by a distance that is less than a depth of the cavity.

15. The accessory of claim 10 wherein a thickness of the connector tab is at least three times a thickness of the flange.

16. The accessory of claim 10 wherein the flange is formed from a flexible metal sheet.

17. The accessory of claim 10 wherein a flexible electrical circuit extends out of the base and is formed along the curved portion of the flange.

18. The accessory of claim 10 wherein the plug connector includes a conductive frame that generally defines a shape of the connector tab and includes openings on both first and second major surfaces.

19. The accessory of claim 18 wherein electronic contacts are disposed in the openings on both the first and second major surfaces and the electronic contacts are surrounded by an encapsulant.

20. The accessory of claim 10 wherein the flange enables the plug connector to be deflected during insertion and removal of the electronic device from the cavity.
